(19) United States
(12) Patent Application Publication
(10) Pub. No.: US 2020/0197951 A1
(43) Pub. Date: Jun. 25, 2020

(54) REDUCED VELOCITY TAILINGS DISTRIBUTOR

(71) Applicant: SYNCRUDE CANADA LTD. in trust for the owners of the Syncrude Project as such owners exist now and in, Fort McMurray (CA)

(72) Inventors: PAUL BELAND, FORT MCMURRAY (CA); LYTON PILGRIM, FORT MCMURRAY (CA)

(21) Appl. No.: 16/717,755

(22) Filed: Dec. 17, 2019

Related U.S. Application Data
(60) Provisional application No. 62/782,989, filed on Dec. 20, 2018.

(51) Int. Cl. B03B 9/02; B03B 5/28; F16L 41/02

(52) U.S. Cl. CPC B03B 9/02; C10G 1/045; F16L 41/023; B03B 5/28

(57) ABSTRACT

A reduced velocity tailings distributor is provided that has been designed to create a sheet flow of tailings, thereby allowing for greater sedimentation and fines capture closer to the discharge points of the distributor.

### FIELD OF THE INVENTION

The present invention relates to a reduced velocity tailings distributor that has been designed to create a sheet flow of tailings, thereby allowing for greater sedimentation and fines capture closer to the discharge points of the distributor.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The key characteristic of Alberta oil sand that makes bitumen economically recoverable is that the sand grains are hydrophilic and encapsulated by a water film which is then covered by bitumen. The water film prevents the bitumen from being in direct contact with the sand and, thus, by slurrying mined oil sand with heated water, the bitumen is allowed to be liberated from the sand grains and move to the aqueous phase.

Recovering bitumen from oil sand ore begins with excavating the ore, such as by using a shovel in an open pit mine. Trucks deliver the excavated ore to a hopper, which in turn feeds the ore to a crusher. The crushed ore is mixed with hot or warm water to form a slurry. A pipeline hydro-transports the slurry to an extraction facility where it is subjected to gravity separation in a primary separation vessel (PSV). In the PSV, the extracted bitumen floats to the top of the vessel as bitumen froth and the sand grains sink and are concentrated in the conical bottom and leave the bottom of the vessel as a wet tailings stream. Middlings, a mixture containing fine solids and bitumen, extend between the froth and sand layers. Some or all of the wet tailings stream and middlings are withdrawn, combined and sent to a secondary flotation process carried out in a deep cone vessel wherein air is sparged into the vessel to assist with flotation of remaining bitumen. This vessel is commonly referred to as a tailings oil recovery vessel, or TOR vessel. The TOR underflow is deposited into a tailings distributor, together with the wet tailings stream from the PSV, for deposition in tailings cells. These tailings are commonly referred to as “extraction tailings” and are comprised primarily of sand and fines such as clays.

Conventional tailings cells are generally constructed as follows. Dozers first “dry dyke” a cell in preparation of pouring of the extraction tailings. The cell comprises a front dyke, from which the extraction tailings are poured, an end dyke, two side dykes and a sloped beaching area. At least one single point discharge pipe is set up on the front dyke and the extraction tailings are poured in the cell, where the sand quickly settles, ideally trapping the fines with it, and the water separates from the sand to form a pond downstream. Dozers track-pack the sand and make sure it is evenly spread. Once the elevation near the discharge point of the at least one pipe is up to design, additional pipe is added to the end of the existing pipe(s) and the feed is discharged farther into the cell. Pipes are continuously added as elevation is met inside the cell.

One of the drawbacks of the current method for extraction tailings disposal is that, due to the high density of the solids and the high velocity of the feed, the discharge pipe may cause very dangerous cutting or trenching within the cell area all the way down to pond level. This will cause deep, wide voids in a cell floor, depending on the height difference between water level and pouring level. These cuts can cross into a neighboring cell creating unforeseen dangers within their respective work areas. Further, these cuts can remove large amounts of sand from the designated cell area, which may end up settling in the ponded water where it is not needed. Finally, these cuts or trenches may create large pockets of fines, which create trafficability issues for cell dozers and result in pockets of mature fine tailings in the pond that never compact.

Another drawback of the current method is that the fines tend to segregate from the coarse sand and remain in suspension in the water phase and, thus, thin fine tailings are also deposited in the pond. Once the thin fine tailings have reached a solids content of about 30-35%, they are referred to as “fluid fine tailings” (FFT) or “mature fine tailings” (MFT), which behave as a fluid-like colloidal material. The fact that fluid fine tailings behave as a fluid and have very slow consolidation rates significantly limits options to reclaim these ponds.

In summary, single point distribution by open ended pipes creates linear flow. When disposing of extraction tailings, which generally have a density above ˜1.30 sg and a fines content greater than ˜28%, this linear flow creates cuts or large washouts in the tailings cells. These cuts wash the sand and fines to the discharge ends of the cells. Pockets of fines may collect, creating access issues for the cell dozer operators. Thus, there is a need in the industry for a method and apparatus for disposing extraction tailings to avoid the drawbacks of current tailings disposal practices.

### SUMMARY OF THE INVENTION

In one aspect, the current application is directed to a reduced velocity tailings distributor which has been designed to create a sheet flow of tailings as opposed to a channeled/linear flow. The formation of a sheet flow slows the overall velocity of the tailings and allows for greater sedimentation and fines capture closer to the discharge points of the device.

In another aspect, a reduced velocity tailings distributor is provided whereby ease of mobility has been integrated into the design. Features to enable assembly, disassembly and relocation using mobile tracked equipment may significantly decrease the time necessary to relocate the distributor.

In another aspect, a method is provided to improved capturing fines in an above water cell and reduce overall MFT accumulation, thereby reducing future MFT handling processes and costs. In one aspect, the method may allow for disposal of extraction tailings without having to dry dyke an area.

Thus, in one aspect, a low velocity tailings distributor is provided, comprising:
a flow splitter comprising a main conduit having a feed inlet for receiving a tailings feed, a first conduit leg and a second conduit leg, each conduit leg extending from the main conduit for splitting the tailings feed into a first tailings stream and a second tailings stream, each conduit leg having an outlet;
a first intake elbow and a second intake elbow connected to the outlet of the first conduit leg and the outlet of the second conduit leg, respectively, the first intake elbow configured to direct the first tailings stream to the right of the flow splitter and the second intake elbow configured to direct the second tailings stream to the left of the flow splitter;
a first spigot manifold comprising a conduit having a first end and a second end, the first end connected to and in fluid communication with the first intake elbow, and a second spigot manifold comprising a conduit having a first end and a second end, the first end connected to and in fluid communication with the second intake elbow;
each spigot manifold having at least one spigot attached thereto and an exit elbow connected to and in fluid communication with the second end.

In another aspect, a method for building a sand dump from extraction tailings comprising sand, fines and water is provided, comprising:
providing a sheet flow of the extraction tailings down at least one section of a sloped beaching area such that a substantial portion of the fines is captured by and deposited with the sand to produce a sand/fines lift; and
allowing the water to drain and collect at the downstream end of the beaching area.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIG. 1 is a top plan view of a reduced velocity tailings distributor constructed in accordance with the principles of the present disclosure.

FIG. 2 is a perspective view of a pontoon used to support a low velocity tailings distributor of the present disclosure.

FIG. 3 is a side cross-sectional view schematic of a sand dump operation of the present disclosure.

### DETAILED DESCRIPTION OF THE PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

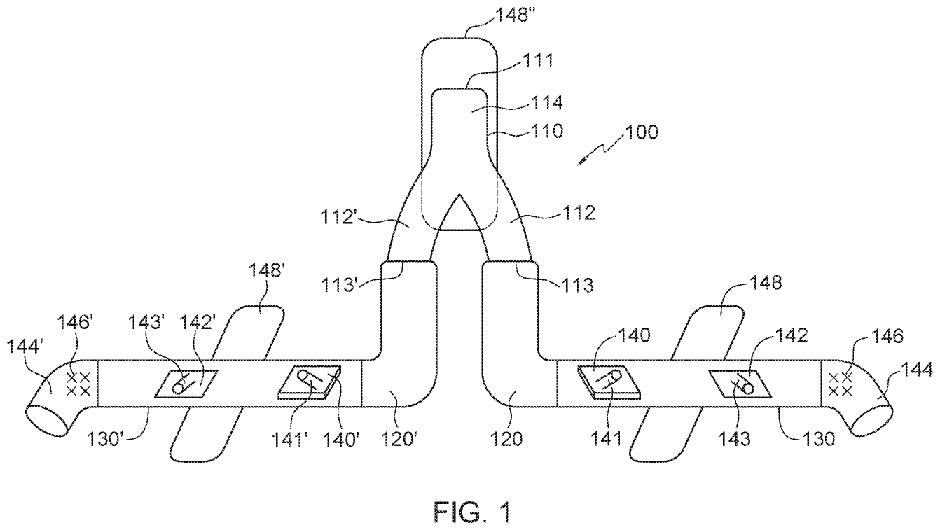

One embodiment of a reduced velocity tailings distributor 100 is shown in FIG. 1. In this embodiment, tailings distributor 100 comprises a Y-shaped flow splitter 110 which receives a single flow of extraction tailings into substantially circular feed inlet 111 of main conduit 114 and discharges two separate flows of tailings therefrom to a first conduit leg 112 and second conduit leg 112′, each conduit leg having an outlet 113 and 113′, respectively. Connected to and in fluid communication with first and second conduit legs 112 and 112′ are first intake elbow 120 and second intake elbow 120′, respectively, each intake elbow having a first end and a second end, each intake elbow being attached to its respective conduit leg at its first end. In one embodiment, the first and second intake elbows are readily detachable from their respect conduit legs.

In one embodiment, the cross-sectional areas of the openings of outlets 113, 113′ are substantially equal to the cross-sectional area of the opening of inlet 111. Thus, the flow velocity discharging from each outlet 113, 113′ can be reduced to about 50% of the velocity of the single flow of tailings entering the inlet 111 where the volumetric flow rate through the inlet 111 and both outlets 113, 113′ is substantially the same. In one embodiment, the junction of conduit legs 112, 112′ to main conduit 114 may be contoured to reduce the occurrence of slurry buildup.

First intake elbow 120 is connected to and in fluid communication with first spigot manifold 130 and second intake elbow 120′ is connected to and in fluid communication with second spigot manifold 130′. In one embodiment, first and second intake elbows 120, 120′ are 90-degree elbows. Use of 90-degree intake elbows may further reduce the velocity of the tailings and spreads the tailings feed equally to the two spigot manifolds 130, 130′. It is understood, however, that the angle of the intake elbows can vary, depending upon the angles of conduit legs 112, 112′ relative to main conduit 114.

Each spigot manifold 130, 130′ is comprised of a first spigot box 140, 140′ and a second spigot box 142, 142′, respectively. First spigot boxes 140, 140′ each have a spigot 141, 141′, respectively, and are configured upwardly approximately 25 degrees to reduce the efficiency of the boxes since the flow is at its highest rate when the first spigot boxes are reached. Second spigot boxes 142, 142′ each have a spigot 143, 143′, respectively, and are configured level to the ground so that the second spigot boxes will distribute approximately the same amount of tailings feed as the first spigot boxes. The remaining tailings feed will be discharged out of discharge elbows 144, 144′. In one embodiment, the discharge elbows 144, 144′ are 90° elbows. In one embodiment, discharge elbows 144, 144′ further comprise internal flow restrictors 146, 146′, respectively, such as baffles, valves, nozzle, spoons, orifices, plates, which are inserted at or near the ends of the discharge elbows to reduce the velocity of the tailings feed exiting therefrom.

Thus, the tailings distributor 100 lowers the velocity of the tailings feed and thereby reduces the cutting problem observed when using single point distribution by open-ended pipes. Further, when the tailings feed is specifically oil sand extraction tailings, tailings distributor 100 will prevent segregation of the accumulated fines clays from the coarse sand.

In one embodiment, reduced velocity tailings distributor 100 further comprises pontoons 148 and 148′, which pontoons elevate spigot manifolds 130, 130′, respectively. As used herein, a “pontoon” means any device, which may comprise a hollow tube, that prevents the tailings distributor from sinking and allows the tailings distributor to glide across tailings formations or lifts built by the deposition of the tailings. The pontoons provide buoyancy to allow the distributor to “float” on the base tailings deposit. Pontoons 148, 148′ may be welded, etc. directly to spigot manifolds 130, 130′, respectively, and are generally positioned off-center and closer to the discharge elbows than the intake elbows. Further, pontoons 148, 148′ are configured to prevent the spigot manifolds from sinking. In one embodiment, the manifolds are elevated approximately 6 feet or 2 meters. It has been shown that if the spigot manifolds 130, 130′ are kept too close to the ground, they will quickly become buried under their own feed. Thus, by raising the spigot manifolds and, optionally, building a back dyke under the elevated left and right spigot manifolds, the manifolds can operate for longer periods of time without becoming buried with coarse sand.

A third pontoon, center pontoon 148″, elevates flow splitter 110. Pontoon 148″ may also be welded directly to flow splitter 110 and is configured to prevent the flow splitter 110 from sinking. Pontoons 148, 148′, 148″ also allow for easy movement of tailings distributor 100 once the tailings feed has been evenly distributed to the desired pour height, e.g., approximately six feet or two meters in one embodiment. Tailings distributor 100 is designed such that the distributor can be easily dismantled into three pieces for easy maneuvering and quick advances once the desired pour height has been reached. In particular, the intake elbows 113, 113′ can be readily separated from flow splitter legs 112, 112′, respectively. Because pontoons 148, 148′ are positioned off-center, as described above, the intake elbows will always be on the ground so that a dozer can hook into the intake elbow and advance each of the spigot manifolds 130, 130′. The pontoons act as skids on the sand to aid in the advancement of the spigot manifolds. Similarly, center pontoon 148″ will also act as a skid over the sand to aid in the advancement of flow splitter 110.

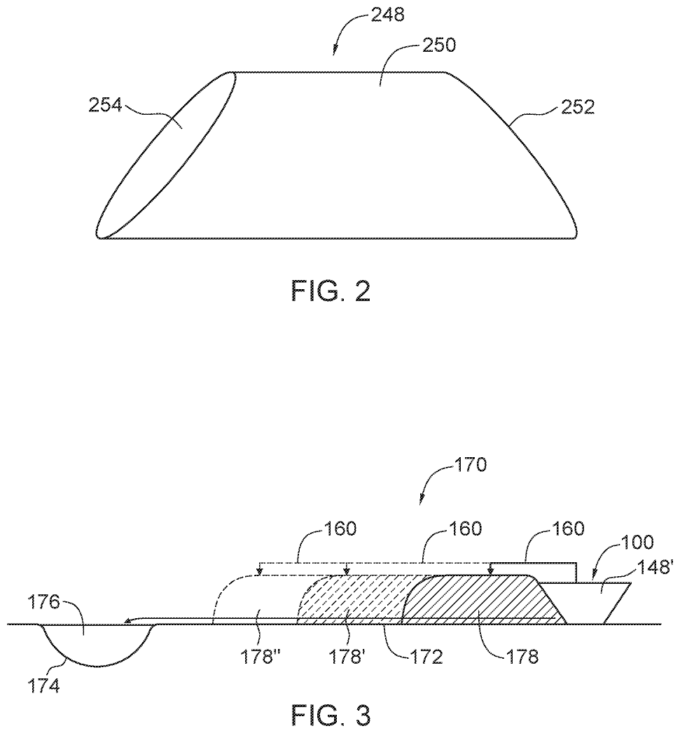

A perspective view of a typical pontoon of the present invention is shown in FIG. 2. Pontoon 248 comprises a length of pipe 250 which has been cut at an angle on both ends 252, 254. Typically, the angle of the cuts are each 45-degrees, however, it is understood that other angle cuts could also be used. In one embodiment, the pontoons may be filled with foam so as to prevent water or solids infiltration.

In one embodiment, the spigot manifolds are made from 60 feet lengths of 24-inch diameter pipe made of carbon steel. The inlet elbows are also 24 inches in diameter and may be made of carbon steel with a chromium carbide overlay. Thus, the feed is equally split in both directions, i.e., left for approximately 75 ft and right for approximately 75 ft, thereby covering a cell area of approximately 200 ft or 60 metres. The pontoons can be made from 60-inch diameter pipe with a 12-foot base and 45-degree angles at each end to form a skid. The ends of the pontoon pipe are capped with sheets of steel plates and filled with expansion foam to prevent the pontoons from filling with sand or water.

The low velocity tailings distributor of the present invention also allows for the pouring of tailings to form a tailings deposit or sand dump for reclamation without having to dry dyke an area. Thus, there is a huge cost saving when using the low velocity tailings distributor of the present invention. FIG. 3 shows one embodiment of a method for building a sand dump from extraction tailings comprising sand, fines and water derived from a mined ore extraction operation by using a low velocity tailings distributor, such as a distributor of the present invention.

FIG. 3 is a side cross-sectional partial transparent view schematic of a tailings deposition method of the present invention. In one embodiment, the tailings are oil sand extraction tailings, which are typically 50% water and 50% solids by weight. The solids fraction can be further defined as being either fine or coarse solids. Typically, the solid fraction contains 80% coarse solids (defined herein as solids greater than 44 microns) and 20% fines (defined herein as solids equal to or less than 44 microns) by weight. A sloped area or beaching area 172 is provided for building the sand dump 170 which may have a collection basin 174 at the far end for collecting drained water and fines 176 which have not been trapped in the coarse solids (primarily sand) present in the extraction tailings.

The extraction tailings 160 are supplied by low velocity tailings distributor 100, whereby the left and right spigot manifold is elevated to 72″ at the base of the 24″ spigot pipe by means of pontoons (only one pontoon, pontoon 148′ shown) and a back dyke may be pushed under the elevated left & right spigot manifolds (not shown). The extraction tailings are dispelled from each of the spigots and left and right elbows in a tailings sheet to a pour height of approximately 6 feet or 2 metres to form a first lift 178 of tailings. Once the first lift 178 is complete, the tailings distributor 100 can be moved onto first lift 178 and tailings 160 are poured again in a tailings sheet to a pour height of approximately 6 feet or 2 metres to form a second lift 178′. Once again, the tailings distributor 100 can be moved onto second lift 178′ and tailings 160 are poured again in a tailings sheet to a pour height of approximately 6 feet or 2 metres to form a third lift 178″.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

We claim:

1. A tailings distributor, comprising:
a flow splitter comprising a main conduit having a feed inlet for receiving a tailings feed, a first conduit leg and a second conduit leg, each conduit leg extending from the main conduit for splitting the tailings feed into a first tailings stream and a second tailings stream, each conduit leg having an outlet;
a first intake elbow and a second intake elbow connected to the outlet of first conduit leg and the outlet of second conduit leg, respectively, the first intake elbow configured to direct the first tailings stream to the right of the flow splitter and the second intake elbow configured to direct the second tailings stream to the left of the flow splitter;
a first spigot manifold comprising a conduit having a first end and a second end, the first end connected to and in fluid communication with the first intake elbow, and a second spigot manifold comprising a conduit having a first end and a second end, the first end connected to and in fluid communication with the second intake elbow;
each spigot manifold having at least one spigot attached thereto and an exit elbow connected to and in fluid communication with the second end.

2. The tailings distributor of claim 1, wherein the flow splitter is generally y-shaped.

3. The tailings distributor of claim 2, wherein the first and second intake elbows are 90° elbows.

4. The tailings distributor of claim 1, wherein each spigot manifold has two spigots.

5. The tailings distributor of claim 4, wherein the spigot closest to the intake elbow is configured upwardly.

6. The tailings distributor as claimed in claim 5, wherein the spigot is configured upwardly 25°.

7. The tailings distributor as claimed in claim 1, wherein the discharge elbows are 90° elbows.

8. The tailings distributor as claimed in claim 1, wherein the discharge elbows further comprise at least one internal flow restrictor.

9. The tailings distributor as claimed in claim 1, further comprising:
a first pontoon and a second pontoon attached to the under portion of the first spigot manifold and the second spigot manifold, respectively.

10. The tailings distributor as claimed in claim 9, further comprising:
a third pontoon attached to the under portion of the flow splitter.

11. The tailings distributor as claimed in claim 9, wherein the pontoons comprise a hollow tube having sealed ends.

12. The tailings distributor as claimed in claim 10, wherein the pontoons comprise a hollow tube having sealed ends.

13. The tailings distributor as claimed in claim 9, wherein the pontoons are attached to the spigot manifolds off-center and closer to the exit elbows than the inlet elbows.

14. The tailings distributor as claimed in claim 9, wherein the pontoons are comprised of pipe sealed at both ends and filled with foam to prevent infiltration of tailings.

15. The tailings distributor as claimed in claim 10, wherein the pontoons are comprised of pipe sealed at both ends and filled with foam to prevent infiltration of tailings.

16. The tailings distributor as claimed in claim 10, further comprising:
a forth pontoon attached to the under portion of the flow splitter.

17. A method for building a sand dump from extraction tailings comprising sand, fines and water, comprising:
providing a first sheet flow of the extraction tailings down a first section of a sloped beaching area such that a substantial portion of the fines is captured by and deposited with the sand to form a first sand/fines lift; and
allowing the water to drain and collect at the downstream end of the sloped beaching area.

18. The method as claimed in claim 17, further comprising:
providing a second sheet flow of the extraction tailings down a second section of the sloped beaching area once the first sand/fines lift is formed such that a substantial portion of the fines is captured by and deposited with the sand to form a second sand/fines lift and allowing the water to drain and collect at the downstream end of the sloped beaching area.
